(19) United States
(12) Patent Application Publication
(10) Pub. No.: US 2025/0356087 A1
(43) Pub. Date: Nov. 20, 2025

(54) INTEGRATED CIRCUIT DESIGN SYSTEM FOR PERFORMING DTCO (DESIGN TECHNOLOGY CO-OPTIMIZATION)

(71) Applicant: SAMSUNG ELECTRONICS CO., LTD., Suwon-si (KR)

(72) Inventors: Hyungock Kim, Suwon-si (KR); Seokhyeong Kang, Pohang-si (KR); Jakang Lee, Pohang-si (KR); Jaeseung Lee, Pohang-si (KR); Seong Hyeon Park, Pohang-si (KR)

(73) Assignee: POSTECH RESEARCH AND BUSINESS DEVELOPMENT FOUNDATION, Pohang-si (KR)

(21) Appl. No.: 18/979,005

(22) Filed: Dec. 12, 2024

(30) Foreign Application Priority Data
May 20, 2024 (KR) 10-2024-0065267

(51) Int. Cl. G06F 30/31; G06F 30/327; G06F 30/392; G06F 117/08; G06N 20/00

(52) U.S. Cl. CPC G06F 30/31; G06F 30/327; G06F 30/392; G06N 20/00; G06F 2117/08

(57) ABSTRACT

An example integrated circuit (IC) design system includes a processor, a storage device, and a design technology co-optimization (DTCO) framework. The storage device is configured to store input parameters and performance, power, and area (PPA) of a plurality of source designs and a target design corresponding to the input parameters as a dataset. The DTCO framework, implemented as software and performed by the processor, is configured to perform a first transfer learning that learns first correlations between the target design and each of the plurality of source designs based on the dataset, and to perform a second transfer learning that learns second correlations between the target design and the plurality of source designs based on the first transfer learning.

### CROSS-REFERENCE TO RELATED APPLICATION

This application claims priority to and the benefit of Korean Patent Application No. 10-2024-0065267 filed in the Korean Intellectual Property Office on May 20, 2024, the entire contents of which are incorporated herein by reference.

### BACKGROUND

In the design process of an integrated circuit (IC), a design technology co-optimization (DTCO) process may be performed to optimize the performance, power, and area (PPA) of the IC. The DTCO process may refer to finding a combination of optimized input parameters for optimizing the PPA of the IC before the process for manufacturing the IC.

Meanwhile, it may require a considerable time to perform the DTCO process in the IC design process. This is because it is difficult to reflect design information in the process of determining optimized input parameters for the ICs, and it costs a lot of money to produce a process design kit (PDK) according to the input parameters. Accordingly, as a way to accelerate the DTCO process to determine the optimized input parameters, a model-based DTCO process such as the Bayesian optimization method is being proposed.

### SUMMARY

The present disclosure relates to an IC design system for constructing a Gaussian process considering similarity between a source design and a target design, and performing DTCO using Bayesian optimization using the Gaussian process as a prediction model.

The present disclosure relates to an IC design system for performing DTCO in which PPA predicting performance on a target design is improved.

The present disclosure relates to an IC design system for performing DTCO providing an optimized combination of input parameters for a target design based on a PPA predicted value for the target design.

In general, according to some aspects, an integrated circuit (IC) design system includes: a processor; a storage device configured to store a plurality of input parameters and PPA of a plurality source designs and a target design corresponding to the plurality of input parameters as a dataset; and a design technology co-optimization (DTCO) framework, implemented as software, and performed by the processor, configured to perform a first transfer learning that learns a first plurality of correlations between the target design and each of the plurality of source designs based on the dataset, and to perform a second transfer learning that learns a second plurality of correlations between the target design and the plurality of source designs based on the first transfer learning.

In general, according to some aspects, a method for performing design technology co-optimization (DTCO) includes: receiving a plurality of datasets for a plurality of source designs and a target design; constructing a PPA prediction model for the target design based on the plurality of datasets; outputting PPA of the target design based on the PPA prediction model; and determining an input parameter of the target design based on the PPA of the target design.

In general, according to some aspects, a method for perform a DTCO using Bayesian optimization includes: performing a first transfer learning that learns a correlation between a first source design from a plurality of source designs and a target design; constructing a first Gaussian process for the first source design and the target design; performing a second transfer learning that learns a correlation between the plurality of source designs and the target design based on first similarity obtained in the process of performing the first transfer learning; constructing a second Gaussian process for the source designs and the target design; and generating an acquisition function that determines an input parameter based on PPA of the target design obtained based on the second Gaussian process.

### BRIEF DESCRIPTION OF THE DRAWINGS

To more fully understand drawings cited in a detailed description of the present disclosure, a brief description of each drawing is provided.

FIG. 1 shows a flowchart of an example of a method for designing an IC and manufacturing the IC.

FIG. 2 shows an example of input parameters.

FIG. 3 shows a block diagram of an example of a DTCO process.

FIG. 4 shows a block diagram of an example of a memory.

FIG. 5 shows a block diagram of an example of a PPA prediction unit in a DTCO framework.

FIG. 6 shows an example of a pre-learning unit of a prediction model construction unit.

FIG. 7 shows an example of a method for obtaining similarity between designs according to a transfer learning executed during a process for constructing a Gaussian process.

FIG. 8 shows an example of a post-learning unit of a prediction model construction unit.

FIG. 9 shows an example of a method for transferring data by a Gaussian process.

FIG. 10 shows an example of a parameter selection unit in a DTCO framework.

FIG. 11 shows an example of a flowchart of a DTCO process.

FIG. 12 shows an example of a flowchart of a DTCO process.

FIG. 13 shows an example of a flowchart of a DTCO process.

FIG. 14 shows an example of a runtime reduction effect of a multi source transfer Gaussian process by performing a pre-learning of similarity between a source design and a target design.

FIG. 15 shows an example of an improvement of performance of a target design expressed by performing pre-learning on similarity.

FIG. 16 shows an example of an improvement of performance of a target design expressed by performing pre-learning on similarity.

FIG. 17 shows an example of an improvement of performance of a target design expressed by performing pre-learning on similarity.

FIG. 18 shows an example of an IC design system.

### DETAILED DESCRIPTION

Hereinafter, implementations of the present disclosure will be described in detail with reference to the accompanying drawings. The same reference numerals are used for the same constituent elements on the drawings, and duplicate descriptions for the same constituent elements are omitted.

Accordingly, the drawings and description are to be regarded as illustrative in nature and not restrictive, and like reference numerals designate like elements throughout the specification. In the flowcharts described with reference to the drawings in this specification, the operation order may be changed, various operations may be merged, certain operations may be divided, and certain operations may not be performed.

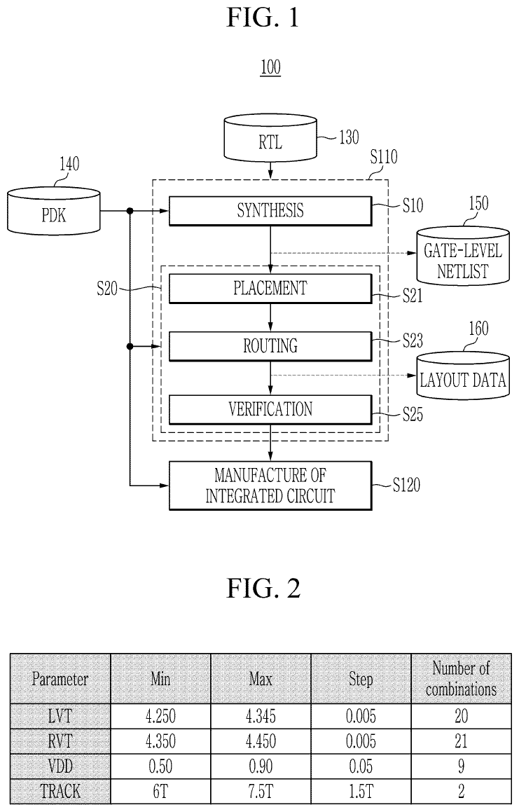

FIG. 1 shows a flowchart of an example of a method for designing an IC and manufacturing the IC.

Referring to FIG. 1, the method 100 for designing and manufacturing an IC may include designing an IC (S110) and manufacturing the IC (S120). The designing an IC of S110 may include generating a gate level netlist 150, designing layout data 160 of a circuit, and verifying the same, and it may be performed by an IC design tool for designing the IC and verifying the same.

The designing an IC of S110 may include a logic synthesis (S10) and a physical design (S20). The logic synthesis S10 may represent generating a gate level netlist 150 from RTL data 130. For example, the IC design tool (e.g., a logic synthesis tool) may perform a logic synthesis for generating the gate level netlist 150 (a netlist hereinafter) by referring to a process design kit 140 from the RTL data 130 written as a VHSIC hardware description language (VHDL) and a hardware description language (HDL) such as the Verilog. The netlist 150 may represent a connection relationship between the gates in the IC and may indicate a logical schematic diagram. The logic synthesis of S10 may be performed based on the process design kit 140 generated based on a specification of the IC. For example, the process design kit 140 may include design rules, operating conditions (e.g., an operating voltage, etc.,) of the IC, threshold voltages, information on standard cells, and wire information. The process design kit 140 may be generated based on input parameters according to the specification of the predetermined IC. A detailed description on the input parameters will be described later with reference to FIG. 2.

The physical design of S20 may include placement (S21), routing (S23), and verification (S25). The placement of S21 may include arranging standard cells. For example, the IC design tool (e.g., P&R tool) may arrange the standard cells used by the netlist 150. The routing of S23 may include routing pins of the standard cells. For example, the IC design tool may generate interconnections for electrically connecting output pins and input pins of the arranged standard cells, and may generate layout data 160 for defining the arranged standard cells and the generated interconnections. The layout data 160 may, for example, have the same format as the GDSII, and may include geometric information on the cells and the interconnections.

The verification of S25 may include verifying the generated layout and correcting the same. Verification items may include a static timing analysis (STA) for verifying whether the layout satisfies a timing condition of the design, a design rule check (DRC) for verifying whether the layout fits the design rule, an electronical rule check (ERC) for verifying whether the layout works without electrical disconnection, and a layout versus schematic (LVS) for checking whether the layout corresponds to the netlist.

The manufacturing of the IC of S120 may include manufacturing a mask, and forming a semiconductor package.

The manufacturing of the IC S120 may include performing an optical proximity correction (OPC) on the layout data 160 generated in the designing of an IC of S110 and generating mask data for forming various patterns on layers, and manufacturing a mask by use of the mask data. The manufacturing of the IC S120 may include performing various types of exposure and etching processes in an iterant way. By the processes, forms of the patterns configured in designing the layout on the silicon substrate may be sequentially formed.

The manufacturing of the IC S120 may include mounting the semiconductor device generated by the IC on a PCB and molding the same with a molding material (i.e., a packaging process). The semiconductor device may be flipped or bonded on the substrate by using contact members according to the packaging process.

FIG. 2 shows an example of input parameters.

As described above in FIG. 1, the process design kit (PDK) may be generated based on the input parameter following the specification of the IC. The input parameter represents a variable for the design and process for generating the process design kit (PDK), and a value of the input parameter may be differently determined depending on the designing and manufacturing specification of the IC. Referring to FIG. 2, the input parameter may include operating voltages (VDD), threshold voltages (LVT and RVT), and tracks of the standard cells in the IC. For example, the IC may include the standard cells with various threshold voltages. In detail, regarding a regular voltage threshold (RVT) cell, a high voltage threshold (HVT) cell has a low rate because of the high threshold voltage but has a less leakage current, and a low voltage threshold (LVT) cell has a high rate because of the low threshold voltage but has a great leakage current. However, the input parameter may not be limited thereto, and may further include many variables for designing and manufacturing the IC, such as a minimum length of the routing wire or a gap between the wires.

In some implementations, minimum and maximum values on the respective input parameters may be predetermined according to the designing and manufacturing specification. For example, as expressed in a table of FIG. 2, the minimum value of the LVT may be predetermined as 4.25V, and the maximum value may be predetermined as 4.345V. The LVT value may be determined at the intervals of 0.005V. Therefore, the LVT for designing and manufacturing the IC may be selected in the range of 4.25V to 4.345V. As the LVT value may be determined at the intervals of 0.005V in the range of 4.25V to 4.345V, the number of the LVTs that are selected may be twenty. As shown in the table of FIG. 2, a minimum value of the RVT may be predetermined as 4.35V, and a maximum value thereof may be predetermined as 4.45V. The RVT value may be determined at the intervals of 0.005V. Therefore, the RVT for designing and manufacturing the IC may be selected in the range of 4.35V to 4.45V. As the RVT value may be determined at the intervals of 0.005V in the range of 4.35V to 4.45V, the number of the RVTs that are selected may be twenty-one. In this way, the range and the number of the values of the selectable input parameters such as the operating voltage (VDD) and the track of the standard cell may be predetermined.

In some implementations, the number of the values of the input parameters that may be selected may be expressed as the number of combinations, and there may be various combinations of the input parameters according to the number of combinations of the respective input parameters. For example, from among various combinations of the input parameters, a first combination of input parameters may represent a combination of which the LVT is 4.25V, the RVT is 4.35V, the operating voltage (VDD) is 0.5V, and the track of the standard cell is 6T, and a second combination of input parameters may represent a combination of which the LVT is 4.25V, the RVT is 4.35V, the operating voltage (VDD) is 0.5V, and the track of the standard cell is 7.5T. That is, the process design kit (PDK) may be generated according to the various and random combinations of the input parameters, and the IC may be designed and manufactured based on the process design kit (PDK). PPA results for the IC may be different from each other depending on the combinations of the input parameters when they have the same design.

In some implementations, the DTCO process for finding an optimized combination of input parameters for optimizing the PPA of the IC may be performed. To accelerate the DTCO process, a model-based optimization method such as the Bayesian optimization method may be used.

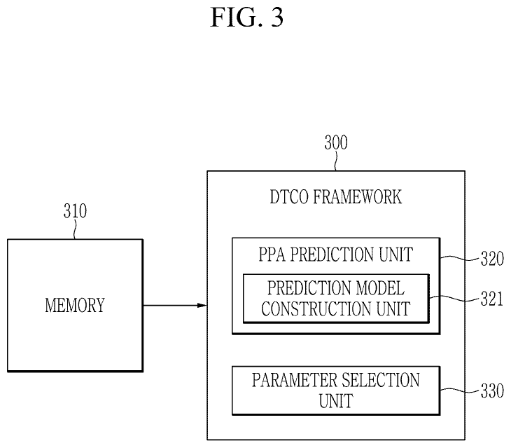

FIG. 3 shows a block diagram of an example of a DTCO process.

In some implementations, the DTCO process may be performed by the DTCO framework 300. The framework may represent a software environment provided in a cooperation form so that the design and implementation of portions that correspond to detailed functions of the software to easily develop the software application or the solution. The software framework may include other components for allowing development of projects or solutions, such as a support program, a compiler, a code library, a tool set, or an application programming interface (API). The DTCO framework 300 may use the Bayesian optimization as an algorithm for selecting the optimized combination of input parameters for optimizing the PPA of the IC. The DTCO framework 300 may perform a DTCO process for predicting a PPA result of the IC that is a target of designing and manufacturing through the Bayesian optimization, and determining the optimized combination of input parameters of the corresponding IC for optimizing the PPA based on the predicted PPA result. The IC that is the target of designing and manufacturing may be referred to as a target design.

To perform the Bayesian optimization, a prediction model for predicting a PPA result of the target design from the input parameters, and an acquisition function for finding the optimized combination of input parameters of the target design based on a predicted result of the prediction model. A Gaussian process may be used as the prediction model for predicting the PPA of the target design.

In some implementations, to construct the Gaussian process for predicting the PPA for the target design, the DTCO framework 300 may use data of designs of the previously designed ICs. The conventionally designed IC design may be referred to as a source design. The data of the source design used by the DTCO framework 300 when constructing the Gaussian process may include input parameter information on the source design and the PPA result of the source design according to the corresponding input parameter.

In some implementations, to construct the Gaussian process for predicting the PPA of the target design using source designs, the DTCO framework 300 may perform a transfer learning on the source design and the target design. The transfer learning represents learning a correlation between the source design and the target design, and the Gaussian process may transfer the PPA of the source design to the PPA of the target design based on the correlation between the source design and the target design, obtained through the transfer learning, to predict the PPA for the target design.

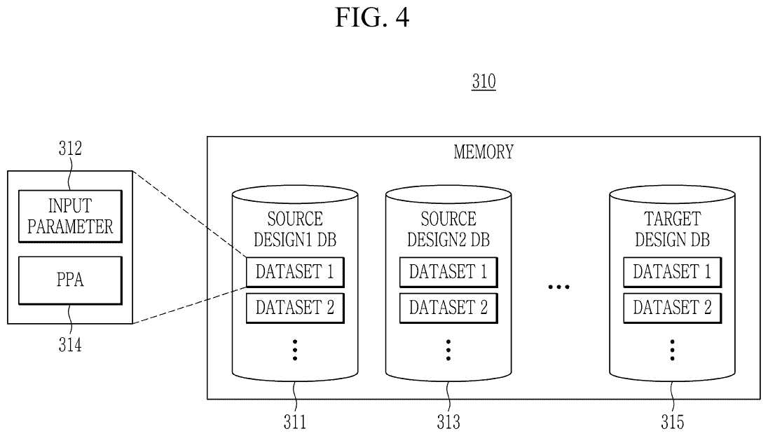

The DTCO framework 300 may include a PPA prediction unit 320 and a parameter selection unit 330, and the PPA prediction unit 320 may include a prediction model construction unit 321. The DTCO framework 300 may receive data of the source design and data of the target design for constructing the Gaussian process from the memory 310. Respective units in the DTCO framework 300 may perform the above-noted operations. The memory 310 and the respective units in the DTCO framework 300 will now be described in detail with reference to FIG. 4 to FIG. 10.

FIG. 4 shows a block diagram of an example of a memory.

In some implementations, the IC design tool may output the PPA of the corresponding IC as a simulation result based on the netlist generated according to various combinations of input parameters determined according to the specification of the IC. The PPA of the IC design output by the IC design tool may be the simulation result, and may be different from the PPA result of the actually designed and manufactured IC. The IC design tool may include a design compiler of Synopsys, and may not be limited thereto.

In some implementations, the memory 310 may include source design databases 311 and 313 and a target design database 315. The respective databases may store datasets of the corresponding designs.

In some implementations, the IC design tool may output the PPA based on the netlist according to various combinations of input parameters of the source design and the target design as a simulation result, and the respective databases of the memory 310 may store the various combinations of input parameters for the respective designs and the PPA output as the simulation result based on them as datasets. For example, the IC design tool may output the PPA based on the netlist generated according to the various combinations (e.g., 200 combinations) of input parameters for the first source design. The memory 310 may receive first input parameters 312 combined in various ways for the first source design and first PPAs 314 based on the same from the IC design tool, and may store them in the first source design database 311 as a first dataset (DATASET1). The IC design tool may output the PPA based on the netlist generated according to the various combinations (e.g., 5 combinations) of input parameters for the target design. The memory 310 may receive the input parameters combined in various ways for the target design and the PPAs based on them from the IC design tool, and may store them in the target design database 315 as the first dataset.

In some implementations, the memory 310 may be a volatile or non-volatile memory. For example, the memory 310 may be a volatile memory such as a random access memory (RAM), a dynamic random access memory (DRAM), a static random access memory (SRAM), or a phase change memory (PCM), or a nonvolatile memory such as a flash memory, a read-only memory/programmable read-only memory (ROM/PROM), or an erasable programmable read-only memory/electronically erasable programmable read-only memory (EPROM/EEPROM), and may not be limited thereto.

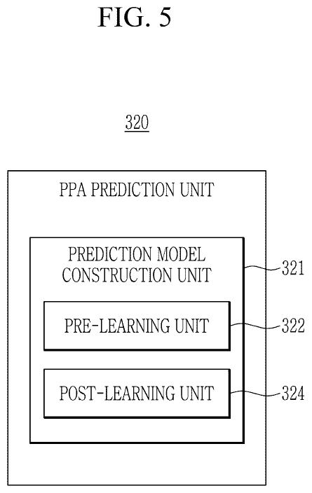

In some implementations, the datasets for the source design and the target design stored in the memory 310 may be used in performing a transfer learning on the source design and the target design. This will be described later with reference to FIG. 5 to FIG. 8.

FIG. 5 shows a block diagram of an example of a PPA prediction unit in a DTCO framework.

In some implementations, the PPA prediction unit 320 may receive the dataset for the source design and the target design from the memory 310 of FIG. 3, and may construct a Gaussian process based on the same. The PPA prediction unit 320 may output the PPA of the target design by using the constructed Gaussian process. In some implementations, the PPA prediction unit 320 may include a prediction model construction unit 321 for performing a transfer learning on the source design and the target design to construct the Gaussian process, and the prediction model construction unit 321 may include a pre-learning unit 322 and a post-learning unit 324.

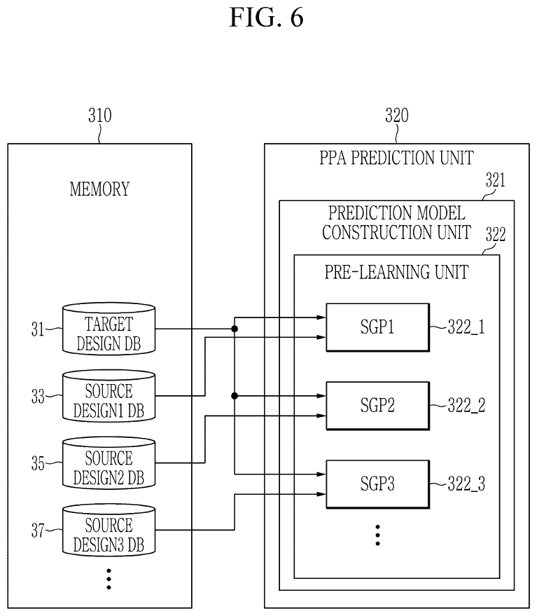

In some implementations, the pre-learning unit 322 may respectively construct the Gaussian process for the target design and the source designs. The pre-learning unit 322 may learn a correlation between the source design and the target design through the transfer learning performed in the process for constructing the Gaussian process, and may output similarity between the source design and the target design obtained through the transfer learning as output data. In some implementations, the post-learning unit 324 may construct the Gaussian process for the target design and the source designs. The post-learning unit 324 may learn the correlation between the source designs and the target design and may construct the Gaussian process for the source designs and the target design based on the similarity between the respective source design and the target design learned by the pre-learning unit 322. The post-learning unit 324 may use the similarity between the source design and the target design obtained from the pre-learning unit 322 as an initial similarity value for the source designs and the target design. The pre-learning unit 322 and the post-learning unit 324 will be described in detail with reference to FIG. 6 to FIG. 8.

FIG. 6 shows an example of a pre-learning unit of a prediction model construction unit.

In some implementations, the prediction model construction unit 321 in the PPA prediction unit 320 may include a pre-learning unit 322.

In some implementations, the pre-learning unit 322 may receive datasets for the respective source designs and the target design from the memory 310, and may construct the Gaussian process for the respective source designs and the target design. The Gaussian process may output a predicted value on input data and an uncertainty on prediction. The predicted value for the input data may represent a PPA predicted value of the target design for the input parameter. The Gaussian process aims at predicting a distribution of a function based on the obtained data, and may use a kernel function to set a degree of the correlation between data.

In some implementations, a kernel equation for showing the correlation between two designs may be defined as in Equation 1.

$${k}_{λ} ( x , {x}^{{}_{′}} ) = \{ \begin{matrix}λ k ( x , {x}^{{}_{′}} ) , x ∈ S and {x}^{{}_{′}} ∈ T \\ k ( x , {x}^{{}_{′}} ) , otherwise\end{matrix} \qquad [ Equation 1 ]$$

here, S is a source design, T is a target design, k is input data (x, x′), that is similarity of input parameters, and λ is similarity between the source design and the target design. The similarity (λ) between designs may represent similarity of the PPA of the source design and the PPA of the target design according to the input parameter.

In some implementations, the kernel function for one source design and one target design may be defined as Equation 2.

$$\tilde{K} = ( \begin{matrix}{K}_{SS} & λ {K}_{S T} \\ λ {K}_{TS} & {K}_{TT}\end{matrix} ) \qquad ( Equation 2 )$$

here, K_{SS} is the kernel function between the source designs, K_{TT} is the kernel function between the target design, K_{ST}(K_{TS}) is the kernel function between the source design and the target design, and λ is the similarity between the source design and the target design. That is, the Gaussian process according to some implementations may further consider the similarity of the PPA of the source design and the target design by the input parameter, that is, the similarity (λ) between the designs in addition to the similarity of the input parameters for the source design and the target design to set the degree of the correlation between the designs.

In some implementations, the pre-learning unit 322 may receive datasets of the source designs and the target design from the memory 310 to construct the Gaussian process one source design and one target design. In detail, the pre-learning unit 322 may receive the datasets of the first source design from the first source design database 33, and may receive the datasets of the target design from the target design database 31. The pre-learning unit 322 may receive the datasets of the second source design from the second source design database 35 and may receive the datasets of the target design from the target design database 31. According to the above-described method, the pre-learning unit 322 may receive the datasets of the source designs from the source designs database and may receive the datasets of the target design from the target design database.

In some implementations, the pre-learning unit 322 may construct a single source transfer Gaussian process (SGP) for transferring the PPA of one source design to the target design PPA based on the datasets of the one source design and the one target design. For example, a first single source transfer Gaussian process 322_1 for the first source design and the target design may be constructed based on the datasets of the first source design and the target design, and a second single source transfer Gaussian process 322_1 for the second source design and the target design may constructed based on the datasets of the second source design and the target design. In some implementations, the single source transfer Gaussian processes 322_1, 322_2, and 322_3 may be simultaneously or sequentially constructed.

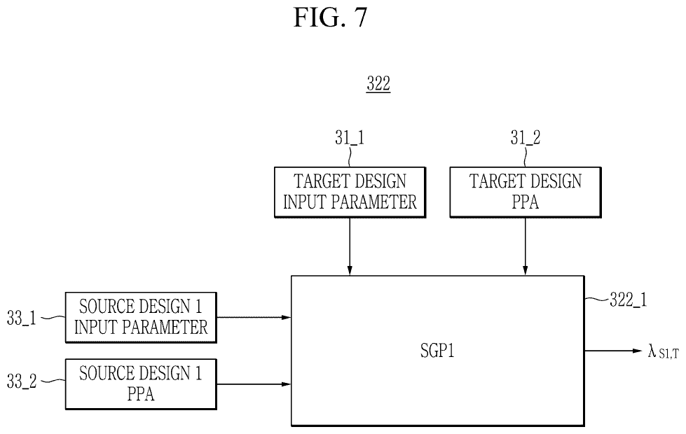

In some implementations, the pre-learning unit 322 may learn the correlation between the source design and the target design through the transfer learning performed in the process for constructing a single source transfer Gaussian process, and may output the similarity (A) between the designs obtained in the process for learning the correlation between the source design and the target design as output data. A detailed method for obtain similarity between designs through the transfer learning performed in the process for constructing a single source transfer Gaussian process will now be described with reference to FIG. 7.

FIG. 7 shows an example of a method for obtaining similarity between designs according to a transfer learning executed during a process for constructing a Gaussian process. For better understanding and ease of description, the first single source transfer Gaussian process SGP1 will be described, and other single source transfer Gaussian processes SGP2, SGP3, . . . in the pre-learning unit 322 may be constructed by a same or similar method.

In some implementations, the pre-learning unit 322 may receive the datasets of the first source design from the first source design database 33 of FIG. 6, and may receive the datasets of the target design from the target design database 31. In some implementations, the pre-learning unit 322 may receive an input parameter 33_1 caused by various combinations (e.g., 200 combinations) of the input parameters for the first source design and a PPA 33_2 of the first source design caused by the input parameters combined in various ways from the first source design database 33 as a dataset, and may receive an input parameter 31_1 caused by various combinations (e.g., 5 combinations) of the input parameters for the target design and a PPA 31_2 of the target design caused by the input parameters combined in various ways from the target design database 31 as a dataset. The pre-learning unit 322 may construct the first single source transfer Gaussian process 322_1 for the first source design and the target design based on the dataset received from the memory 310.

In some implementations, the pre-learning unit 322 may learn the correlation between the first source design and the target design through the transfer learning performed in the process for constructing a first single source transfer Gaussian process 322_1 based on the dataset of the first source design and the dataset of the target design. The correlation between the first source design and the target design may be provided by considering the similarity of the combination of input parameters, and the similarity between the PPAs caused by the input parameter, that is, the inter-design similarity. In some implementations, the pre-learning unit 322 may obtain the similarity (λ_{S1,T}) between the first source design and the target design through the transfer learning performed in the process for constructing a first single source transfer Gaussian process 322_1, and may output the similarity (λ_{S1,T}) between the designs as output data. The similarity (A) between the designs may have a value between −1 and 1, the similarity between the respective designs may increase when the value approaches |λ|=1, and the respective designs may be irrelevant to each other when it is given as |λ|=0. The pre-learning unit 322 may obtain the similarity (λ) between the designs through the transfer learning between the source design and the target design, and may output the same as output data.

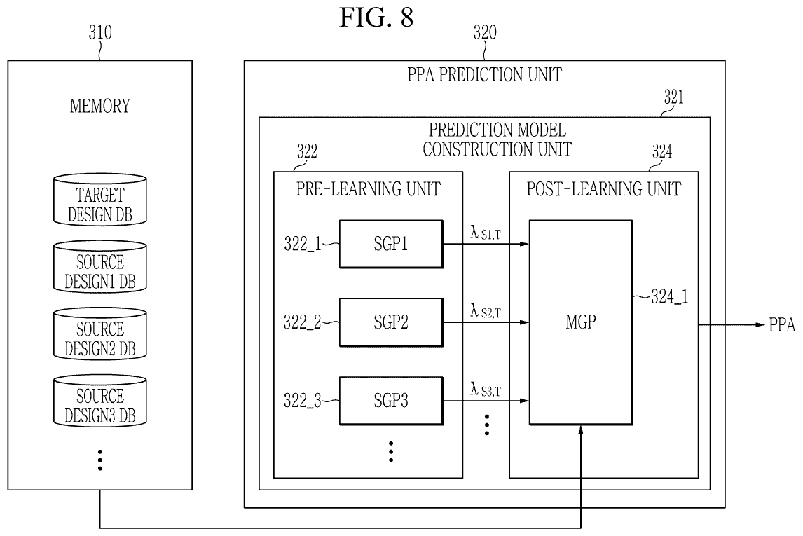

FIG. 8 shows an example of a post-learning unit of a prediction model construction unit.

In some implementations, the prediction model construction unit 321 in the PPA prediction unit 320 may include a pre-learning unit 322 and a post-learning unit 324.

In some implementations, the post-learning unit 324 may receive the dataset for the source designs and the target design from the memory 310, and may construct the Gaussian process for the source designs and the target design. The post-learning unit 324 may use the kernel function to set the degree of correlation between the source designs and the target design in the process for constructing a Gaussian process.

In some implementations, the kernel equation for expressing the correlation between the source designs and the target design may be defined as Equation 3.

$${k}_{n m} ( {x}_{n} , {x}_{m} ) = \{ \begin{matrix}{λ}_{i j} k ( {x}_{n} , {x}_{m} ) , {x}_{n} ∈ {D}_{i} and {x}_{m} ∈ {D}_{j} , i \neq j \\ k ( {x}_{n} , {x}_{m} ) , {x}_{n} , {x}_{m} ∈ {D}_{i}\end{matrix} \qquad ( Equation 3 )$$

here, D is the design, k represents the input data (xₙ,xₘ) that is the similarity of the input parameter, and λᵢⱼ represents the inter-design similarity (Dᵢ, Dⱼ). That is, the post-learning unit 324 may consider the similarity between the source designs that are different from each other in addition to the similarity between the source design and the target design. As described, the kernel function on the source designs and the target design may be defines as expressed in Equation 4.

$$\tilde{K} = ( \begin{matrix}{K}_{S 1 , S 1} & … & {λ}_{S 1 , T} {K}_{S 1 , T} \\ {λ}_{S 2 , S 1} {K}_{S 2 , S 1} & … & {λ}_{S 2 , T} {K}_{S 2 , T} \\ ⋮ & ⋱ & ⋮ \\ {λ}_{T , S 1} , {K}_{T , S 1} & … & {K}_{T , T}\end{matrix} ) \qquad ( Equation 4 )$$

In some implementations, the post-learning unit 324 may construct a multi source transfer Gaussian process (MGP) 3241 for transferring the PPA of the source designs as the PPA of the target design based on the datasets of the source designs and the target design. The post-learning unit 324 may receive the datasets of the source designs and the target design from the memory 310 to construct the multi source transfer Gaussian process 324_1 for the source designs and the target design. The datasets received by the post-learning unit 324 may be the same as or similar to the datasets received by the pre-learning unit 322 of FIG. 6 so no detailed thereof will be described.

In some implementations, the post-learning unit 324 may learn the correlation between the source designs and the target design through the transfer learning performed in the process for constructing a multi source transfer Gaussian process 324_1. The correlation between the source designs and the target design may be a value generated by considering the similarity between the PPAs caused by the input parameter, that is, the inter-design similarity in addition to the similarity of the combinations of input parameters. In some implementations, the post-learning unit 324 may use the similarity (λ_{S1,T}, λ_{S2,T}, . . . ) between the designs received from the pre-learning unit 322 as an initial value of the similarity between the source designs and the target design learned to construct the multi source transfer Gaussian process 324_1. That is, the post-learning unit 324 may receive the similarity (λ_{S1,T}, λ_{S2,T}, . . . ) between the respective source designs and the target design from the pre-learning unit 322, may performing an additional fine tuning thereon, and may construct the multi source transfer Gaussian process 324_1 for the source designs and the target design. As described, in the process for constructing the multi source transfer Gaussian process 324_1 for the source designs and the target design, the post-learning unit 324 may use the inter-design similarity received from the pre-learning unit 322 as initial similarity, thereby reducing a time for constructing the multi source transfer Gaussian process and improving prediction performance.

In some implementations, the post-learning unit 324 may output the PPA for the target design as output data of the multi source Gaussian process 324_1. The post-learning unit 324 may transfer the PPA of the source designs to the PPA of the target design by using the multi source transfer Gaussian process 324_1.

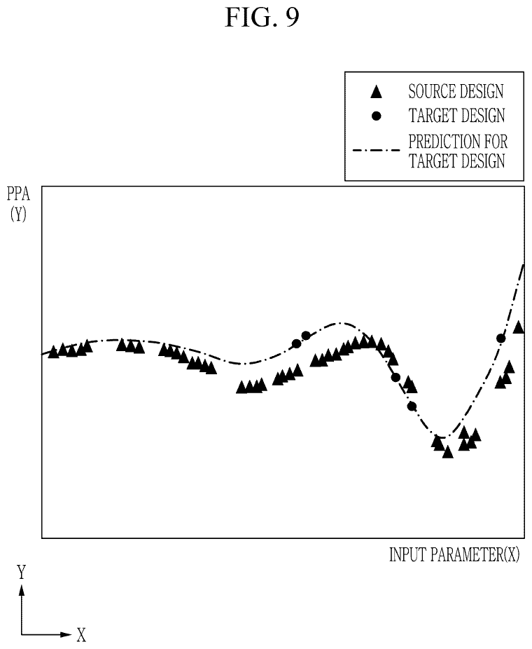

FIG. 9 shows an example of a method for transferring data by a Gaussian process. In detail, an axis of a first direction (X) may indicate the input parameter, an axis of a second direction (Y) may indicate the PPA, and a method for transferring the PPA of the source design to the PPA of the target design will be described.

In some implementations, the PPA prediction unit 320 of FIG. 3 may receive combinations of input parameters (e.g., 200 combinations) for the source designs and the PPA of the source designs according to the combinations of input parameter from the memory 310 as the dataset. The PPA prediction unit 320 may receive the combination of input parameters (e.g., 5 combinations) for the target design and the PPA of the target design caused by the combination of input parameters from the memory 310 as the dataset. Referring to FIG. 9, triangular points may represent the PPA that corresponds to the combination of input parameters of the source designs, and circular points may represent the PPA that corresponds to the combination of input parameters of the target design.

In some implementations, the PPA prediction unit 320 may use the Gaussian process as the prediction model for predicting the PPA of the target design caused by the combination of input parameters, and the PPA prediction unit 320 may use the design set for the source designs to construct the Gaussian process. In some implementations, the PPA prediction unit 320 may obtain the similarity between the source designs and the target design and may learn the correlation between the source designs and the target design by performing the transfer learning on the source designs and the target design to construct the Gaussian process. The PPA prediction unit 320 may predict the PPA for the target design by transferring the PPA for the source design to the PPA for the target design based on the correlation between the source designs and the target design.

Referring to FIG. 9, the number of the datasets (circular) for the previously obtained target design may be less than the number of the datasets (triangular points) of the previously obtained source design. Hence, it is difficult to predict the PPA caused by various combinations of input parameters for the target design by using the dataset for the target design. In some implementations, the PPA prediction unit 320 may transfer the PPA for the source design to the PPA for the target design based on the correlation between the source designs and the target design learned in the process for constructing a Gaussian process. The PPA prediction unit 320 may output the PPA (a dotted line of FIG. 9) for the target design that corresponds to various combinations of input parameters as the output data.

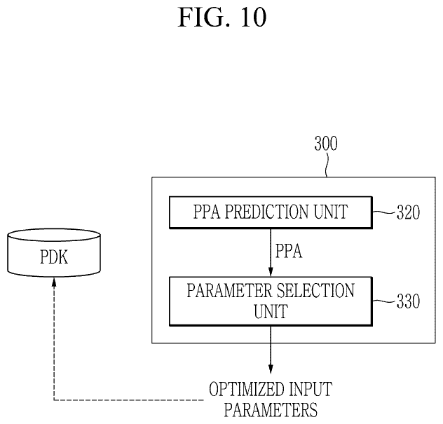

FIG. 10 shows an example of a parameter selection unit in a DTCO framework.

In some implementations, the PPA prediction unit 320 in the DTCO framework 300 may output the PPA for the target design by transferring the PPA for the source design to the PPA for the target design by use of the Gaussian process. In some implementations, the parameter selection unit 330 may select an optimized combination of input parameters for the target design based on the PPA received from the PPA prediction unit 320. For example, the parameter selection unit 330 may select a combination of input parameters for reducing a size without degrading performance, a combination of input parameters for increasing performance while maintaining the same size, and a combination of input parameters for maintaining the performance with a small force as the optimized combinations of input parameters.

In some implementations, the parameter selection unit 330 may use an acquisition function to find the optimized combination of input parameters for the target design based on the PPA received from the PPA prediction unit 320. In some implementations, the acquisition function for finding the optimized combination of input parameters according to the PPA of the target design may be defined as Equation 5.

$$α ( x ; κ ) = μ ( x ) - κ σ ( x ) \qquad ( Equation 5 )$$

here, α(x;κ) represents the acquisition function, and p and a are output values by the Gaussian process, and respectively indicate a predicted value (μ) of the input parameter (x) and uncertainty (σ) for the prediction. The predicted value may represent the PPA.

The parameter selection unit 330 may obtain the optimized combination of input parameters for the target design from Equation 6.

$${x}_{*} = arg mi n ( α ( x ; κ ) ) \qquad ( Equation 6 )$$

here, x_{*} represents the optimized combination of input parameters. That is, the parameter selection unit 330 may find the lowest point of the acquisition function according to the output value (a predicted value and uncertainty on the prediction) of the Gaussian process received from the PPA prediction unit 320, and may select the value of the corresponding point as the optimized parameter combination. This is however an example, and the DTCO framework may select the optimized combination of input parameters from the PPA predicted value of the target design according to various methods.

In some implementations, the DTCO framework 300 may output the optimized combination of input parameters for optimizing the PPA of the target design, and the IC design tool may generate a process design kit (PDK) for designing and manufacturing the IC.

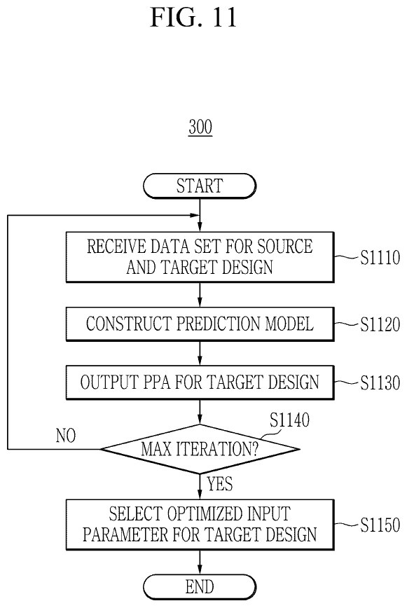

FIG. 11 to FIG. 13 show example flowcharts of a DTCO process.

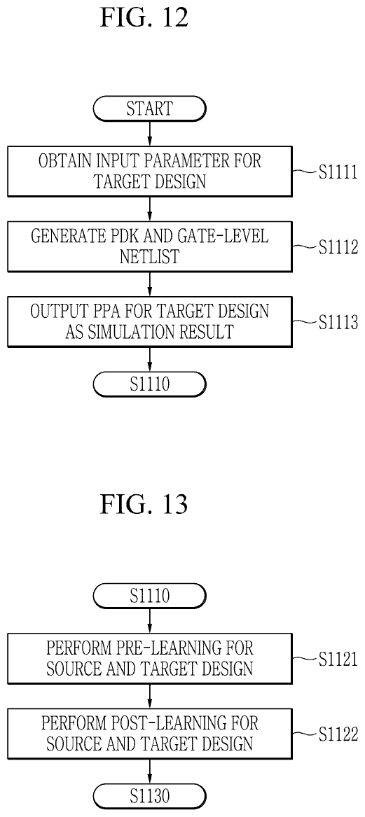

In some implementations, the DTCO framework may receive datasets on the source designs and the target design from an external memory (S1110). The datasets may include various combinations of input parameters and the PPAs of the source design or the target design corresponding to the same. Referring to FIG. 12 together, the IC design tool may obtain the combination of input parameters for the selected target design based on the specification of the target design (S1111). The IC design tool may generate a process design kit (PDK) of the target design and a gate level netlist based on the combination of input parameters (S1112), and may output the PPA for the target design as a simulation result based on the gate level netlist (S1113). The combination of input parameters for the target design and the corresponding PPA may be transmitted to the DTCO framework as the dataset for the target design.

Referring to FIG. 11, the DTCO framework may construct the Gaussian process as a prediction model for Bayesian optimization based on the datasets of the source designs and the target design (S1120). Referring to FIG. 13 together, the DTCO framework may perform a similarity pre-learning on the respective source designs and the target design to construct the Gaussian process for the respective source designs and the target design (S1121). The similarity pre-learning may represent the transfer learning performed in the single source transfer Gaussian process (SGP) process for transferring the PPA of one of the source designs to the PPA of the target design, and may indicate the similarity between the PPAs that correspond to the combination of input parameters of one of the source designs and the target design. The DTCO framework may obtain the inter-design similarity for the respective source designs and the target design through the transfer learning performed in the process for constructing a single source transfer Gaussian process. In some implementations, the DTCO framework may obtain the similarity by the number of the source designs as a result of the similarity pre-learning. The DTCO framework may perform a similarity post-learning for constructing the multi source transfer Gaussian process for the source designs and the target design based on the inter-design similarity obtained as a result of the similarity pre-learning (S1122). The similarity post-learning may represent the transfer learning performed in the multi source transfer Gaussian process (MGP) process for transferring the PPA of the source designs to the PPA of the target design, and may indicate the similarity between the PPAs that corresponds to the combination of input parameters of the source designs and the target design. The DTCO framework may obtain inter-design similarity for the source designs and the target design through the transfer learning performed in the process for constructing a multi source transfer Gaussian process. The DTCO framework may use the inter-design similarity obtained as the result of similarity pre-learning as an initial value of the similarity between the designs learned in the similarity post-learning process. The DTCO framework may construct the multi source transfer Gaussian process for the source designs and the target design through the similarity post-learning.

Referring to FIG. 11, in some implementations, the DTCO framework may output the PPA of the target design according to the combination of input parameters based on the multi source transfer Gaussian process constructed through the similarity post-learning (S1130). The DTCO framework may output the PPA for the target design by transferring the PPA for the source designs to the PPA for the target design based on the multi source Gaussian process.

In some implementations, the above-described stages may be repeatedly performed by a predetermined number of times (S1140). The number of times for repeatedly performing the above-described stages may be predetermined by a designer of the IC or a user of the DTCO framework.

In some implementations, the DTCO framework may select the optimized combination of input parameters based on the PPA of the target design (S1150). For example, the DTCO framework may select the optimized combination of input parameters for the target design by using the acquisition function for finding the optimized combination of input parameters for the target design based on the PPA of the target design. However, this is not limited thereto.

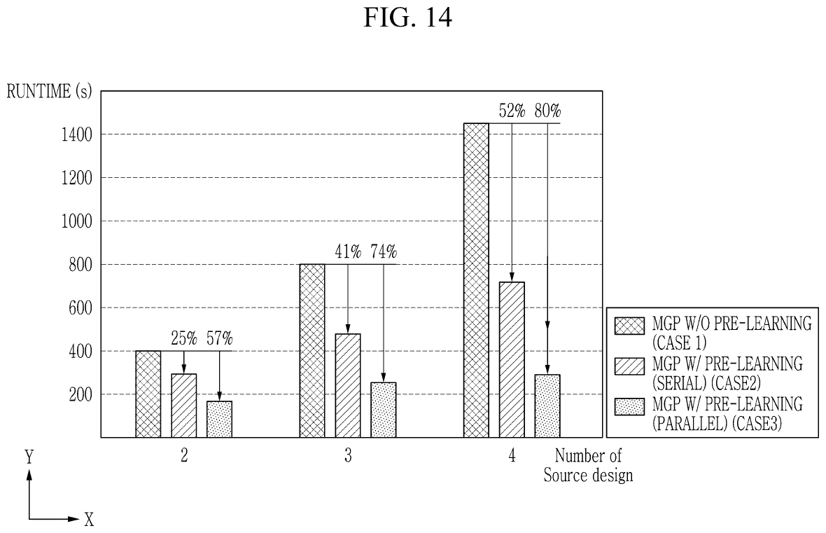

FIG. 14 shows an example of a runtime reducing effect of a multi source transfer Gaussian process generated by performing a similarity pre-learning between a source design and a target design.

Referring to FIG. 14, the axis of the first direction (X) may indicate the number of source designs, and the axis of the second direction (Y) may indicate the runtime of the multi source transfer Gaussian process.

In some implementations, when the number of source designs is 2, a similarity pre-learning of the respective source designs and the target design may be sequentially performed, the runtime of the multi source transfer Gaussian process (CASE2) for the source designs and the target design performed based on the result of similarity pre-learning may be reduced by about 25%, compared to the runtime of the multi source transfer Gaussian process (CASE1) for the source designs and the target design performed without performing the pre-learning for the source design and the target design. Further, the similarity pre-learning for the respective source designs and the target design may be performed simultaneously (or in a parallel way), and the runtime of the multi source transfer Gaussian process (CASE3) for the source designs and the target design performed based on the result of similarity pre-learning may be reduced by about 57%, compared to the runtime of the multi source transfer Gaussian process (CASE1) for the source designs and the target design performed without performing the pre-learning for the source design and the target design.

In some implementations, when the number of source designs is 3, the similarity pre-learning for the respective source designs and the target design may be sequentially performed, and the runtime of the multi source transfer Gaussian process (CASE2) for the source designs and the target design performed based on the result of similarity pre-learning may be reduced by about 41%, compared to the runtime of the multi source transfer Gaussian process (CASE1) for the source designs and the target design performed without performing the pre-learning for the source design and the target design. Further, the similarity pre-learning for the respective source designs and the target design may be performed simultaneously (or in a parallel way), and the runtime of the multi source transfer Gaussian process (CASE3) for the source designs and the target design performed based on the result of similarity pre-learning may be reduced by about 74%, compared to the runtime of the multi source transfer Gaussian process (CASE1) for the source designs and the target design performed without performing the pre-learning for the source design and the target design. As described, the runtime of the multi source transfer Gaussian process for the source designs and the target design may be reduced by performing the similarity pre-learning for the respective source designs and the target design.

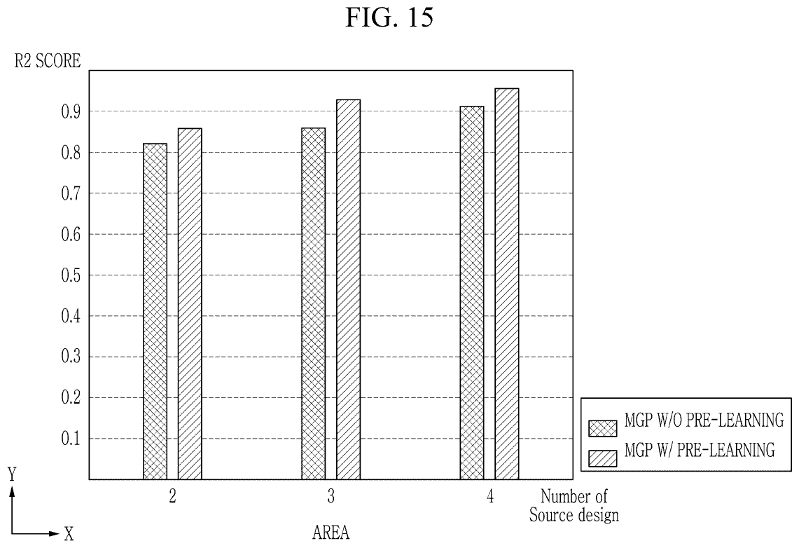

FIG. 15 to FIG. 17 show improvements of performance of a target design expressed by performing pre-learning on similarity according to some implementations. Referring to FIG. 15 to FIG. 17, the axis of the first direction (X) may indicate the number of source designs, the axis of the second direction (Y) may indicate a score of R2, and the score of R2 may be an estimation index on the performance of the Bayesian optimization model and may represent the correlation between the actual value and the predicted value, and the performance of the model may increase as the score of R2 increases.

FIG. 15 shows an example of a score of R2 on an area (AREA) of a target design by performance of pre-learning on similarity. Referring to FIG. 15, regarding the number of the entire source designs, an area predicted value of the target design by the multi source transfer Gaussian process performed when performing the pre-learning may be further similar to an actual value, compared to an area predicted value of the target design by the multi source transfer Gaussian process performed without performing the pre-learning.

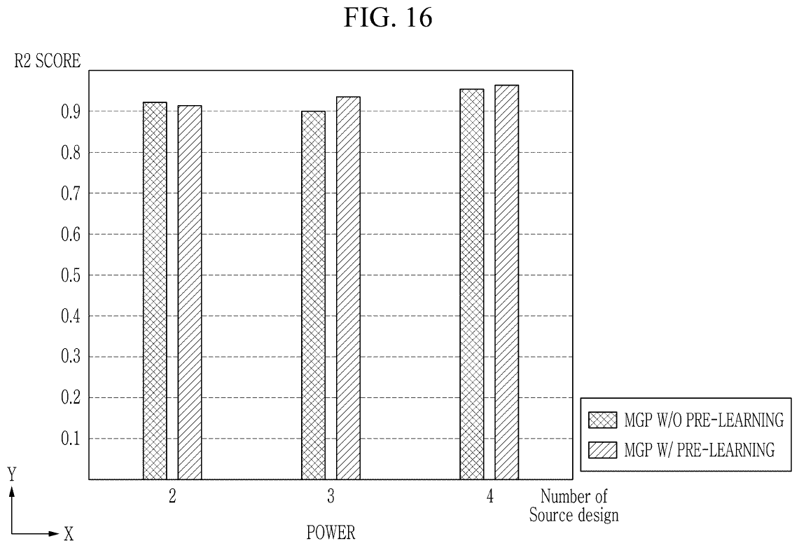

FIG. 16 shows an example of a score of R2 on power consumption (POWER) of a target design by performance of pre-learning on similarity. Referring to FIG. 16, regarding the number of most of the source designs, a power consumption predicted value of the target design by the multi source transfer Gaussian process performed when performing the pre-learning may be further similar to an actual value, compared to a power consumption predicted value of the target design by the multi source transfer Gaussian process performed without performing the pre-learning.

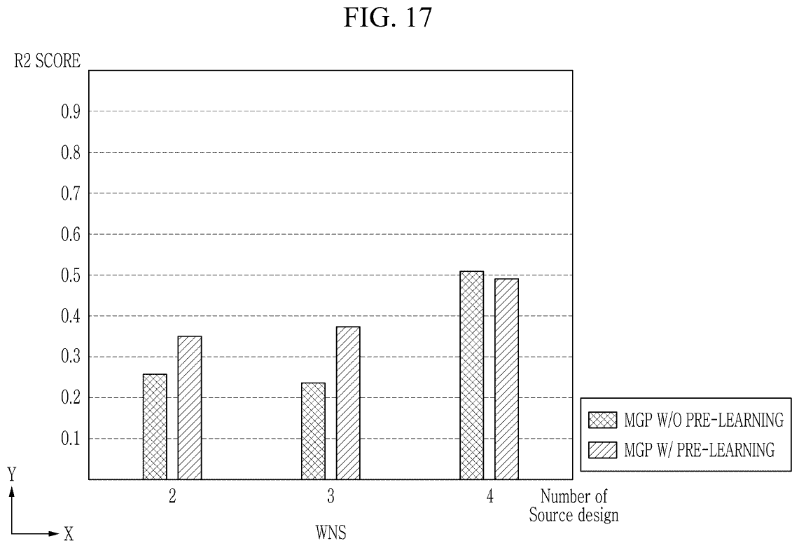

FIG. 17 shows an example of a score of R2 on performance of a target design, that is, a worst negative slack (WNS) by performance of pre-learning on similarity. Referring to FIG. 16, regarding the number of most of the source designs, a predicted value of a WNS of the target design by the multi source transfer Gaussian process performed when performing the pre-learning may be further similar to an actual value, compared to a predicted value of a WNS of the target design by the multi source transfer Gaussian process performed without performing the pre-learning.

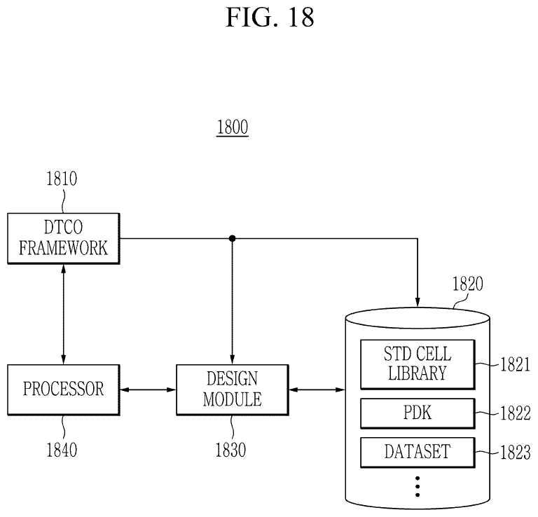

FIG. 18 shows an example of an IC design system.

The design system 1800 may include a DTCO framework 1810, a storage device 1820, a design module 1830, and a processor 1840. The design system 1800 of FIG. 18 may perform at least a portion of the DTCO process of the IC shown in FIG. 1 to FIG. 13 and a design operation of the IC described in the method for designing an IC. The design system 1800 may be realized with an integrated device, and hence, it may be referred to as a design device. The design system 1800 may be provided as an exclusive device for designing the IC, and may be a computer for driving various simulation tools or design tools.

The storage device 1820 may include a standard cell library 1821 and a process design kit (PDK) 1822. The standard cell library 1821 may include a height, a size, and timing information on the standard cell. The process design kit 1822 may be generated based on the input parameter selected according to the specification of the IC to be designed. The input parameter may include an operating voltage (VDD) of a transistor, threshold voltages (LVT and RVT), and a height of the standard cell, which is not limited thereto. The standard cell library 1821 and the process design kit 1822 may be provided to the design module 1830 and the DTCO framework 1810 from the storage device 1820. The number of cell libraries included in the storage device 1710 may be changed in many ways. The design system 1800 may output the PPA based on the netlist according to the various combinations of input parameters for the source design and the target design as a simulation result, and the storage device 1820 may store the various combination of input parameters for the designs and the PPA output as the simulation result based on the same as datasets.

The design module 1830 may generate a gate level netlist from an RTL by using the process design kit 1822. The design module 1830 may generate a layout design according to the gate level netlist by using the standard cell library 1821. Here, a term of “module” may represent software, hardware such as a field programmable gate array (FPGA) or an application specific integrated circuit (ASIC), or combinations of software and hardware.

The processor 1840 may control and support various operations performed by the design system 1800. For example, the processor 1840 may include a microprocessor, an application processor (AP), a digital signal processor (DSP), and a graphic processing unit (GPU). FIG. 18 shows one processor 1840, and the design system 1800 may include processors depending on implementations.

The DTCO framework 1810 may be performed by the processor 1840 of the design system 1800. The DTCO framework 1810 may perform the DTCO process for finding the optimized combination of input parameters for optimizing the PPA of the IC before the process for manufacturing an IC. The DTCO framework 1810 may use the Bayesian optimization method as a method for accelerating the DTCO process for determining the optimized input parameter. A prediction model for predicting a PPA result of the target design and an acquisition function for finding an optimized combination of input parameters for the target design based on the predicted result of the prediction model to perform the Bayesian optimization, and the DTCO framework 1810 may use the Gaussian process as the prediction model for predicting the PPA result of the target design. The DTCO framework 1810 may receive the PPA of the source design and the target design according to the process design kit 1822 generated by the design module 1830, and may perform the similarity pre-learning for the source design and the target design based on the same. The DTCO framework 1810 may construct the multi source transfer Gaussian process for transferring the PPA of the source designs to the PPA of the target design based on the similarity pre-learning result for the source design and the target design. The DTCO framework 1810 may select the combination of input parameters for the target design by using the acquisition function based on the PPA of the target design obtained from the multi source transfer Gaussian process. The DTCO process performed by the DTCO framework 1810 may reduce the time for constructing the multi source transfer Gaussian process and may increase the prediction performance by performing the similarity pre-learning between designs.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While this disclosure has been described in connection with what is presently considered to be practical implementations, it is to be understood that the disclosure is not limited to the disclosed implementations, but, on the contrary, is intended to cover various modifications and equivalent arrangements included within the spirit and scope of the appended claims.

What is claimed is:

1. An integrated circuit (IC) design system comprising:
a processor;
a storage device configured to store a plurality of input parameters and a plurality of performance, power, and area (PPA) of a plurality of source designs and a target design corresponding to the plurality of input parameters as a dataset; and
a design technology co-optimization (DTCO) framework, implemented as software and performed by the processor, configured to perform a first transfer learning that learns a first plurality of correlations between the target design and each of the plurality of source designs based on the dataset, and to perform a second transfer learning that learns a second plurality of correlations between the target design and the plurality of source designs based on the first transfer learning.

2. The IC design system of claim 1, wherein the storage device includes:
a first plurality of datasets including a first plurality of input parameters from the plurality of input parameters and a first plurality of PPA of a first source design from the plurality of source designs corresponding to the first plurality of input parameters, and
a second plurality of datasets including a second plurality of input parameters from the plurality of input parameters and a second plurality of PPA of the target design corresponding to the second plurality of input parameters.

3. The IC design system of claim 2, wherein the DTCO framework is configured to obtain first similarity between the first source design and the target design in a process that performs the first transfer learning based on the first plurality of datasets and the second plurality of datasets received from the storage device and to perform the second transfer learning based on the first similarity.

4. The IC design system of claim 3, wherein the DTCO framework is configured to construct a Gaussian process that transfers the plurality of PPA of the plurality of source designs to a PPA of the target design based on a result of the second transfer learning.

5. The IC design system of claim 4, wherein the DTCO framework includes:
a pre-learning circuit configured to
receive the first plurality of datasets and the second plurality of datasets from the storage device, and
output the first similarity, and
a post-learning circuit configured to
receive the dataset from the storage device,
receive the first similarity from the pre-learning circuit, and
output the PPA of the target design based on the Gaussian process.

6. The IC design system of claim 4, wherein the DTCO framework is configured to
generate an acquisition function based on the PPA of the target design, and
determine an input parameter of the target design based on the acquisition function.

7. The IC design system of claim 6, wherein the DTCO framework is configured to determine a value of a lowest point of the acquisition function as the input parameter of the target design.

8. The IC design system of claim 3, wherein the first similarity is similarity of the first plurality of PPA and the second plurality of PPA.

9. The IC design system of claim 6, comprising:
a design circuit configured to design an IC based on a process design kit (PDK) generated according to the determined input parameter of the target design.

10. The IC design system of claim 1, wherein an input parameter of the plurality of input parameters includes an operating voltage, a threshold voltage, and a track of a standard cell in an IC.

11. A method for performing design technology co-optimization (DTCO) comprising:
receiving a plurality of datasets for a plurality of source designs and a target design;
constructing a performance, power, and area (PPA) prediction model for the target design based on the plurality of datasets;
outputting a PPA of the target design based on the PPA prediction model; and
determining an input parameter of the target design based on the PPA of the target design.

12. The method of claim 11, wherein constructing the PPA prediction model for the target design based on the plurality of datasets includes:
performing a first transfer learning that obtains a correlation between a first source design and the target design based on a first dataset of the first source design from the plurality of source designs and a second dataset of the target design, and
constructing a first Gaussian process that transfers a PPA of the first source design to a PPA of the target design.

13. The method of claim 12, wherein
the first dataset includes a first plurality of input parameters and the PPA of the first source design corresponding to the first plurality of input parameters, and
the second dataset includes a second plurality of input parameters and the PPA of the target design corresponding to the second plurality of input parameters.

14. The method of claim 13, wherein constructing the PPA prediction model for the target design based on the plurality of datasets includes:
obtaining first similarity in a process that performs the first transfer learning,
performing a second transfer learning that obtains a correlation between the plurality of source designs and the target design based on the first similarity and the plurality of datasets, and
constructing a second Gaussian process that transfers a plurality of PPA of the plurality of source designs to the PPA of the target design.

15. The method of claim 14, wherein the first similarity is similarity of the PPA of the first source design corresponding to the first plurality of input parameters and the PPA of the target design corresponding to the second plurality of input parameters.

16. The method of claim 11, wherein determining the input parameter of the target design based on the PPA of the target design includes:
generating an acquisition function based on the PPA of the target design, and
determining a value corresponding to a lowest point of the acquisition function as the input parameter of the target design.

17. A method for performing design technology co-optimization (DTCO) using Bayesian optimization comprising:
performing a first transfer learning that learns a correlation between a first source design from a plurality of source designs and a target design,
constructing a first Gaussian process for the first source design and the target design;
performing a second transfer learning that learns a correlation between the plurality of source designs and the target design based on first similarity obtained in the process of performing the first transfer learning,
constructing a second Gaussian process for the source designs and the target design; and
generating an acquisition function that determines an input parameter based on a performance, power, and area (PPA) of the target design obtained based on the second Gaussian process.

18. The method of claim 17, wherein constructing the first Gaussian process includes:
obtaining a first plurality of input parameters and a first plurality of PPA of the first source design corresponding to the first plurality of input parameters as a first plurality of datasets,
obtaining a second plurality of input parameters and a second plurality of PPA of the target design corresponding to the second plurality of input parameters as a second plurality of datasets, and
obtaining the first similarity based on the first plurality of PPA and the second plurality of PPA.

19. The method of claim 18, wherein constructing the second Gaussian process includes:
obtaining a third plurality of input parameters and a third plurality of PPA of the plurality of source designs corresponding to the third plurality of input parameters as a third plurality of datasets,
performing the second transfer learning based on the second plurality of datasets, the third plurality of datasets, and the first similarity, and
transferring the third plurality of PPA to the PPA of the target design based on the second transfer learning.

20. The method of claim 17, wherein the method includes:
determining a value of a lowest point of the acquisition function as the input parameter of the target design.
